(19) United States
(12) Patent Application Publication
(10) Pub. No.: US 2026/0283183 A1
(43) Pub. Date: Sep. 24, 2026

(54) Prebiotic Fiber Candy and Method of Making the Same

(71) Applicant: Daniel William Harrell, North Miami Beach, FL (US)

(72) Inventor: Daniel William Harrell, North Miami Beach, FL (US)

(21) Appl. No.: 19/458,185

(22) Filed: Jan. 23, 2026

Related U.S. Application Data
(63) Continuation of application No. 18/321,142, filed on May 22, 2023, now abandoned.
Application No. 18/321,142 is a continuation of application No. 16/861,806, filed on Apr. 29, 2020, now abandoned.

(51) Int. Cl. A23G 3/42; A23G 3/34

(52) U.S. Cl. CPC A23G 3/42; A23G 3/001; A23G 3/0014; A23G 3/0051

(57) ABSTRACT

A comestible may include a solid mixture of at least 98% by weight inulin fiber by weight and 1.6% by weight other edible ingredients. The comestible may be a hard candy, cotton or spun fiber candy or nut or seed brittle. The comestible may be formed heating inulin fiber powder to its melting point or above and allowing the melted inulin fiber to cool and harden.

### RELATED APPLICATIONS

This is a continuation application of the U.S. application Ser. No. 18/321,142 filed May 22, 2023, which is a continuation application of the U.S. application Ser. No. 16/861,806 filed Apr. 29, 2020. The disclosure of the prior applications is hereby incorporated by reference herein in its entirety.

### BACKGROUND OF THE INVENTION

### 1. Field of the Disclosure

The present invention relates to comestibles or foodstuffs for human consumption, more particular the incorporation of a prebiotic fiber into products composed solely from plant derived ingredients or a mixture of plant derived ingredients and ingredients from other sources with improvements in sensory and nutritional properties. More specifically, the present invention relates to a new concept for healthy confectionery products including a composition incorporating inulin which may be formed from inulin powder such as chicory root fiber powder.

### 2. Description of the Related Art

Unfortunately, Americans consume less than half of the recommended daily fiber amount (38 and 25 g/day for men and women aged 19-50, respectively) and fewer than 5% of people get enough fiber from their diet. Thus, many consumers want convenient foods and supplements, including snack bars that are a good source of fiber and many consumers are interested in consuming more inulin due to its prebiotic fiber health benefits. Fewer than 5% of people have enough fiber in their diet. To promote beneficial digestive health, it is desired that snack bars and other food products such as hard candy and other confectioneries include more fiber and low sugar. Therefore, it is desirable to produce a high fiber, edible composition formed of inulin with many uses including confectioneries and increasing the fiber content of snack bars.

Inulin is a naturally occurring polysaccharide belonging to a class of dietary fiber that is known as fructans. Further, inulin is also considered a prebiotic fiber. Inulin may be extracted from many different types of plants but is most often extracted from chicory. Inulin has attained the GRAS status in USA and is extensively available in about 36,000 species of plants, among these species of plants chicory is considered the richest source of inulin. Commonly, inulin is used as a prebiotic, fat replacer, sugar replacer, texture modifier also beneficial for the development of functional foods to improve health due to its role in gastric health. Commercially, inulin is available in both liquid or syrup as well as a powder form.

Some of the common plants from which inulin is sourced include chicory, stevia, monk fruit and artichoke. Typically, it is commercially available as chicory root fiber powder or syrup.

Conventional hard and soft candies as well as coating for snack bars are formed with an aqueous process utilizing commercially available inulin syrup or a liquid slurry or syrup may be formed by mixing inulin powder with a liquid such as water. Further, water, binders, starch and/or flavorings may be added to the inulin syrup or slurry to form the specific type of product that is required. Next, the mixture is boiled or heated (i.e., upto 310 F) in a kettle or other container. Finally, the product may be placed in molds and cooled to form the individual candy pieces.

Forming candy or other inulin containing products using this type of processing is not optimal. Time and energy are required to heat the aqueous mixture. Further, it may be labor intensive to mix the binders, flavors and inulin and water as well as pour the heated mixture into the molds. Further, the process and use of binders and starch requires much oversight and can be easily burnt or inappropriately mixed. Also, the need for binders and water in each piece of candy limits the amount of inulin and therefore prebiotic fiber in each piece of candy.

While some conventional candies and snack bar coatings may incorporate inulin, many other confectioneries do not incorporate this great source of prebiotic fiber. For example, cotton candy, which is also called spun sugar, and peanut or other nut brittles fail to incorporate inulin fiber.

As a result, an inulin containing hard candy that is more cost effectively produced with a relatively higher percentage of inulin content is desired. Also, to assist ingestion of the required amount of daily fiber, it is desirable to incorporate inulin fiber into many different comestibles.

### BRIEF SUMMARY OF THE DISCLOSURE

The limitations of use of inulin as a liquid slurry or syrup combined with binders and/or starch are overcome by the invention of this disclosure which utilizes solid inulin in the powder form. A hardened inulin composition which may incorporate a relatively higher percentage of inulin and thus a relatively higher percentage of dietary fiber is provided as well as several examples of the use of the composition. Further, a method of making the hardened inulin compositions, according to the present disclosure, is provided.

In some aspects, the techniques described herein relate to a confectionary including: a noncompressible, solid candy including inulin fiber and other edible ingredients.

In some aspects, the techniques described herein relate to a confectionary, wherein the other edible ingredients include a flavoring, a food color, a sweetener or any combination thereof.

In some aspects, the techniques described herein relate to a method of making a confectionery, the method including steps of: providing a base powder including inulin fiber powder; and melting the base powder by applying heat to the base powder and forming a melted base powder.

In some aspects, the techniques described herein relate to a method, further including the steps of: removing the melted base powder from the heat.

In some aspects, the techniques described herein relate to a method, wherein the melted base powder is a hard candy.

In some aspects, the techniques described herein relate to a method, further including the steps of: placing the base powder in candy molds before the step of melting the base powder; and melting the base powder in the candy molds by applying heat at a temperature at or above 352.2° F.

In some aspects, the techniques described herein relate to a method further including the steps of: providing edible ingredients in a powdered form, the edible ingredients including flavoring, color, sweetener or any combination thereof; mixing the edible ingredients and the base powder together to form a mixture; and the step of melting further includes melting the mixture such that the inulin fiber powder and one or more of the edible ingredients are melted and form a solid.

In some aspects, the techniques described herein relate to a comestible including: at least one spun fiber including inulin fiber.

In some aspects, the techniques described herein relate to a comestible, wherein the at least one spun fiber is a plurality of spun inulin fibers.

In some aspects, the techniques described herein relate to a comestible, wherein the spun fiber forms a portion of cotton candy.

In some aspects, the techniques described herein relate to a comestible, wherein the plurality of spun inulin fibers forms cotton candy.

In some aspects, the techniques described herein relate to a comestible, wherein the at least one spun fiber further includes: a flavoring, sweetener, food coloring, or combination thereof.

In some aspects, the techniques described herein relate to a method of making a comestible, the method including steps of: providing a first portion including inulin fiber powder; providing a second portion including pieces or a powder of nut, a peanut, a seed, any combination thereof; mixing the first portion and the second portion together to form a mixture; and encasing the second portion with the first portion by heating the mixture to above a melting point of inulin fiber powder and melting the first portion.

### BRIEF DESCRIPTION OF THE SEVERAL VIEWS OF THE DRAWINGS

The foregoing summary, as well as the detailed description of the preferred embodiments of the present invention, will be better understood when read in conjunction with the appended drawings. For the purpose of illustrating the invention, there is shown in the drawings, which are diagrammatic, embodiments that are presently preferred. It should be understood, however, that the present invention is not limited to the precise arrangements and instrumentalities shown. In the drawings:

FIG. 1 is a flow diagram of a method of making an inulin composition according to this disclosure;

FIG. 2A is a flow diagram of a method making cotton candy according to this disclosure;

FIG. 2B is a conventional portable cotton candy machine; and

FIG. 3 is a flow diagram of a method of making a brittle including inulin fiber powder.

### DETAILED DESCRIPTION OF THE INVENTION

Multiple embodiments of comestibles formed from inulin powder rather than the inulin syrup or liquid as well as the methods of forming the comestibles are provided in this disclosure. For example, inulin powder may be used to form cotton candy, hard candy and peanut or other nut brittle (collectively “brittle”). Depending on the desired taste and type of comestible, the inulin powder may or may not be combined with a flavoring or sweetener.

As used herein, the words “hard candy” refers to a comestible or confectionary item including confectioneries that are noncompressible at room temperature. That is, hard candy maintains its shape at room temperature and unlike soft candy would most likely crack rather than disform under pressures relatively higher than standard or atmospheric pressure.

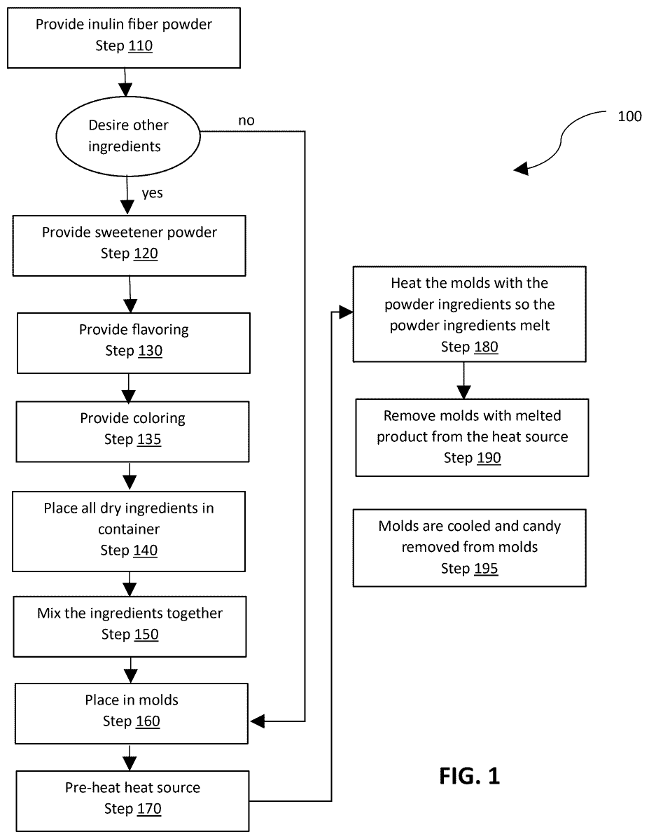

A method 100 of making hard candy formed from inulin powder is provided in FIG. 1. Utilizing method 100, hard candy may be produced without harmful ingredients to humans (even healthy people). The candy may be unflavored or flavored in various varieties with an appealing taste. Further, the candy may be produced in shapes having an appealing taste, hardness and glass-like glossy surface. Further, the candy may be made economically with a rapid high heat process that can be done with ease. One of the most widely used ingredients in this context is inulin powder derived from chicory root fiber powder. The inulin powder is used here as a functional ingredient in hard candy according to this disclosure.

In step 110, inulin fiber powder is provided. This is a solid, semi-crystalline form of inulin fiber and is not a liquid, syrup or slurry. The inulin powder is commercially available and derived from many different plants such as chicory, stevia, and monk fruit. As provided in step 110, inulin derived from chicory root fiber may be provided.

The candy may be formed of 100% inulin powder without adding a sweetener, coloring or flavoring. As a result, the inulin powder or inulin fiber powder is referred to as a base powder. If color or flavoring is desired, then the addition of other edible ingredients such as sweetener, flavoring and coloring may be necessary as provided in steps 120, 130 and 135.

In step 120, a sweetener may be provided as dry or powdered ingredients. If a low sugar hard candy is desired, then artificial or naturally low sugar sweeteners may be used in powdered form. Examples of low sugar natural and artificial sweeteners may be stevia, neotame, etc. For high sugar sweeteners, powdered forms of sucrose, glucose and fructose such as brown sugar and white sugar, etc. may be utilized. Other types of sugar sweeteners may also be used including maltodextrin.

In step 130, a desired flavoring may be provided in a concentrated powdered form. These are commercially available in many forms including natural and artificial. For example, citric acid powder may be utilized for lemon lime flavoring. Other examples include blackberry, blueberry and banana natural flavor powders.

In step 135, a desired coloring may be provided in powdered form which is commercially available. Natural food coloring powder may be derived from various fruits and vegetables as well as annatto seeds. Both the natural food coloring and flavoring may be obtained from various commercial sources including naturesflavors.com.

In step 140, the dry powder ingredients including the chicory root fiber and if desired, coloring, flavoring and sweetener are combined in a bowl or other suitable container for mixing. The recommended example of proportions of the ingredients include about 16 ounces of dry inulin powder in the form of chicory root fiber powder and ¼ ounce of other edible ingredients. In other words, the ratio of inulin to the other ingredients may be about 64:1 by weight and about 99.15% inulin fiber and about 0.85% other edible ingredients providing flavoring, color and sweetening, etc. In other words, the hard candy is at least 99.15% inulin fiber and 0.85% other edible ingredients. This allows for the maximization of the amount of prebiotic fiber in the resulting hard candy.

It is also foreseeable that other proportions of ingredients are possible depending on taste preferences. That is, the proportion of other edible ingredients may be greater than 1.6% by weight resulting in a decrease in the amount of inulin fiber powder.

In step 150, the dry ingredients are mixed in the container. A suitable mixing tool may be utilized such as a spoon or spatula for hand mixing and an electric type of mixer for larger quantities. Mixing should be performed for a sufficient time to uniformly distribute the inulin and other dry ingredients.

In step 160, the mixed dry ingredients are placed into at least one or plurality of candy molds. The mixture may fill the entire mold or the mixture may fill the mold until the desired level for the corresponding size is achieved.

Preferably, the molds are formed of silicone for ease of removing the hard candy from the molds, but molds formed of other suitable materials such as metal, metal alloys, and ceramic, etc. may be utilized.

The shape and size of the molds may vary depending on the shape and size of the desired candy. For example, the molds may be square, rectangular, ring, donut and any shape desired as the mixed powder ingredients may take in shape.

In step 170, an oven pre-heated to a desired temperature is provided. The temperature ranges which may be used to form the hard candy range from about 352.2° F. to about 1500° F. and vary based on the type of oven that is used. More specifically, the inulin powder must be heated to or above its melting point which is 352.2° F. at standard temperature and pressure.

In the event a stationary oven is utilized, the oven should be heated to a temperature in a range of about 352.2° F. to about 750° F. A rapid pass heat treatment system or oven may also be utilized at heat treatment processes with temperatures from about 750° F. to about 1500° F.

In step 180, heat is applied to the molds containing the dry ingredients. The molds are placed into the provided heat source for heating. While in the oven or rapid pass system, the powdered ingredients melt and take the form of the provided mold.

In step 190, the melted product or mixture in the molds is removed from the oven. It is noted that in either stationary or rapid pass system, the required time within the oven depends on the temperature of the oven as well as the thickness of the candy and mold, etc. In either situation, it is estimated that the time to melt the dry mixture into candy is about 30 seconds to about 3 minutes for the candy and up to seven to 8 minutes for the nut or seed brittle.

In step 195, the molds with the now formed candy are removed from the oven and the melted product is allowed to cool. As the melted product cools, a hard candy or confection is removed from the molds. The resultant hard candy is solid, thick, crunchy, noncompressible with a glass-like uniform glossy surface.

It is noted that the color of the candy is dependent upon the inulin or chicory root fiber powder and any flavoring, coloring and other dry ingredients added to the inulin powder. Commercially available inulin powder is an opaque white and when subjected to this process without any other ingredients, the inulin will remain an opaque white once melted. It is noted that at temperatures recommended in Step 170, inulin fiber may undergo caramelization via the Maillard process. Therefore, unless caramelization is desired, it is recommended that the molds be removed from the heat source before the color of the melted inulin powder begins to turn brown or caramelize.

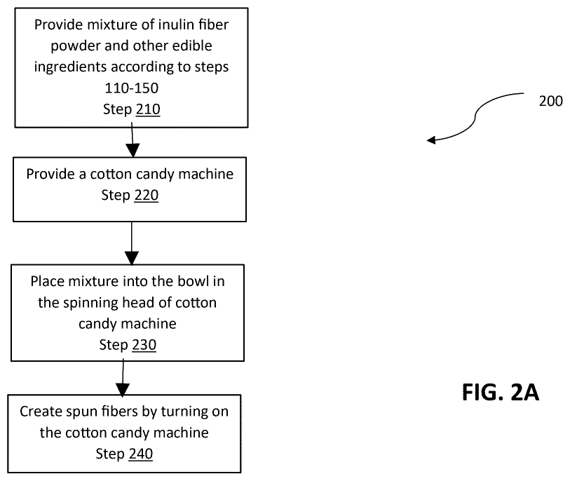

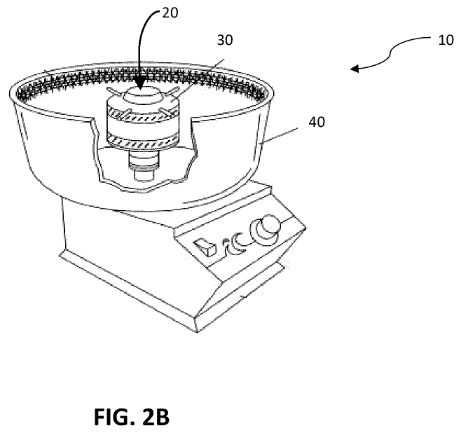

A method 200 for making cotton candy is provided in FIG. 2A and begins with step 210 which includes providing an inulin powder mixture including any desired flavoring, sweeteners and colorings, etc. This mixture may be provided according to steps 110 through 150 of method 100.

In step 220, a cotton candy machine is provided. An example of a portable, conventional cotton candy machine is provided in FIG. 2B.

In step 230, the inulin powder mixture is placed into a bowl 20 within the center of a spinning head 30 of the cotton candy machine.

In step 240, the cotton candy machine is switched on and heaters around the bowl begin to melt the inulin powder mixture into a liquid. As the machine spins, the liquified mixture is forced radially outwardly from the center into the outer collecting bowl 40 surrounding the spinning head 30. Once in the collecting bowl 40, the liquified mixture cools and forms cotton candy as spun fibers of inulin which have the flavor and color of the inulin powder mixture.

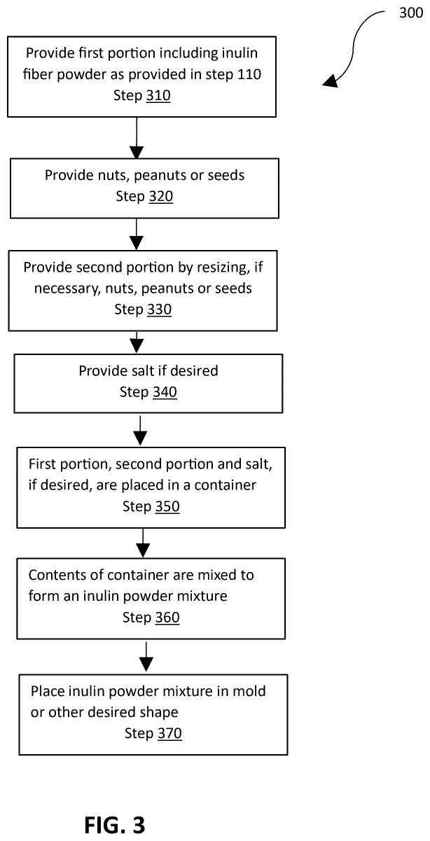

FIG. 3 depicts a method 300 of making a comestible such as peanut or other nut, or seed brittle using inulin powder. First in step 310, inulin powder forming a first portion of brittle is provided as discussed in step 110 of method 100. Next, in step 320, the desired peanuts, nuts, seeds or combination thereof are provided.

In step 330, a second portion of the brittle is provided by breaking the peanuts, nuts, seeds or combination thereof into a fine powder and/or broken into pieces. This may be accomplished using mechanical devices such as a mortar and pestle, grinder, food processer or other apparatus or machine. It is noted that whole nuts, seeds and peanuts, etc may be used as the second portion if resizing is not desired.

In step 340, salt may be provided if desired for the brittle

In step 350, the first portion, second portion and, if desired, salt are combined in a bowl or container suitable for mixing. The recommended proportions are about 30 grams of first portion to about 12 grams of second portion with a pinch of salt. This is about 2.5 grams of inulin fiber to each gram of second portion (i.e., whole nuts or seeds, fine powder and/or broken pieces) or about 60% first portion (i.e., inulin powder) and 40% second portion.

In step 360, an inulin powder mixture is formed by mixing together the contents of the bowl as provided in step 150 of method 100.

In step 370, the inulin powder mixture may be placed in different types of molds depending on the desired product. For example, if hard candy shaped brittle is desired, the inulin powder mixture may be placed in candy molds as described in step 160 of method 100. If larger rectangular and thin shapes are desired, the inulin powder mixture may be placed in rectangular, shallow mold. Further, the inulin powder mixture may be placed in a baking sheet and broken into smaller pieces once it is fully formed.

At this point, steps 170 through 195 corresponding to method 100 may be followed. If a seed, peanut or nut powder is used in portion two, the result, will be a great tasting, finely dispersed peanut, nut and/or seed powder encased by the melted inulin powder. If whole nuts, seeds and peanuts or resized pieces thereof are included in portion 2, these whole or resized pieces will be encased in melted inulin powder.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as generally defined in the appended claims.

1. A method of making a confectionery, the method comprising:
providing a base powder including inulin fiber powder; and
melting the base powder by applying heat to the base powder and forming a melted base powder.

2. The method of claim 1, further comprising:
removing the melted base powder from the heat.

3. The method of claim 2, wherein the melted base powder is a hard candy.

4. The method of claim 1, further comprising:
placing the base powder in candy molds before melting the base powder; and
melting the base powder in the candy molds by applying heat at a temperature at or above 352.2° F.

5. The method of claim 1 further comprising:
providing edible ingredients in a powdered form, the edible ingredients including flavoring, color, sweetener or any combination thereof;
mixing the edible ingredients and the base powder together to form a mixture; and
melting the base powder further comprises melting the mixture such that the inulin fiber powder and one or more of the edible ingredients are melted and form a solid.

6. A comestible comprising:
at least one spun fiber including inulin fiber.

7. The comestible of claim 6, wherein the at least one spun fiber is a plurality of spun inulin fibers.

8. The comestible of claim 6, wherein the spun fiber forms a portion of cotton candy.

9. The comestible of claim 7, wherein the plurality of spun inulin fibers forms cotton candy.

10. The comestible of claim 6, wherein the at least one spun fiber further comprises:
a flavoring, sweetener, food coloring, or combination thereof.

11. A method of making a comestible, the method comprising:
providing a first portion including inulin fiber powder;
providing a second portion including pieces or a powder of nut, a peanut, a seed, any combination thereof;
mixing the first portion and the second portion together to form a mixture; and
encasing the second portion with the first portion by heating the mixture to above a melting point of inulin fiber powder and melting the first portion.
